(19) United States
(12) Patent Application Publication
(10) Pub. No.: US 2026/0138139 A1
(43) Pub. Date: May 21, 2026

(54) APPARATUS FOR THE HIGH-GRADIENT MAGNETIC SEPARATION OF NANOSCALE DIAMAGNETIC PARTICLES

(71) Applicant: The Florida State University Research Foundation, Inc., Tallahassee, FL (US)

(72) Inventor: Petru Andrei, Tallahassee, FL (US)

(21) Appl. No.: 19/386,403

(22) Filed: Nov. 12, 2025

Related U.S. Application Data
(60) Provisional application No. 63/721,036, filed on Nov. 15, 2024.

(51) Int. Cl. B03C 1/033; B03C 1/00; B03C 1/28

(52) U.S. Cl. CPC B03C 1/0335; B03C 1/002; B03C 1/28; B03C 2201/18; B03C 2201/26

(57) ABSTRACT

Disclosed herein is an apparatus for separation of diamagnetic particles of sub-micron diameter from a fluid. The disclosed apparatus includes a first magnetic coil including a hollow center and a separation unit including an outer enclosure and a second magnetic coil. The second magnetic coil includes a single-layer of windings of a magnetic wire and at least one nonmagnetic wire on a nonmagnetic core where the first magnetic coil houses the separation unit in the hollow inner center. Also disclosed herein is a method of using the apparatus.

### CROSS-REFERENCE TO RELATED APPLICATIONS

This application claims the benefit of priority to U.S. Provisional Application No. 63/721,036 filed Nov. 15, 2024, which is hereby incorporated herein by reference in its entirety.

### BACKGROUND

Diamagnetic particles have magnetic susceptibilities that are orders of magnitude smaller

than the magnetic susceptibility of paramagnetic and ferromagnetic materials. Due to the extremely small value of the magnetic susceptibility of diamagnetic particles, the magnetic separation of these particles is difficult. Improved methods and devices for the separation of nanoscale diamagnetic particles are needed. The devices, methods, and systems disclosed herein address these and other needs.

### SUMMARY

In accordance with the purposes of the disclosed devices, methods, and systems as embodied and broadly described herein, the disclosed subject matter relates to an apparatus for the high-gradient magnetic separation of nanoscale diamagnetic particles, and methods of use thereof.

Disclosed herein is an apparatus for separating submicron diamagnetic particles with a diameter below 1 μm from nonmagnetic and paramagnetic particles of similar size, which is not previously described in the literature. The apparatus presented here is capable of separating diamagnetic particle with a radius of 100 nm and less. The apparatus has a number of advantages over the existing high-gradient magnetic separator (HGMS) systems. First, the magnetic field gradients produced by our system are three orders of magnitude larger than those in the state-of-the-art diamagnetic separators; hence, our system can separate much smaller diamagnetic particles than commercial separators. Second, our system requires only one magnetic coil and is significantly easier to fabricate than systems based on quadrupole structures, which require four coils. Third, the proposed apparatus is able to separate diamagnetic from paramagnetic particles (while traditional HGMS or systems that use ferrofluids are not able to segregate them if the particles have the same radius). The apparatus can be used for the extraction of diamagnetic elements such as yttrium and lanthanum from raw materials. The apparatus can also be useful in medical applications, particularly for the separation of biological particles (e.g. cells, bacteria, and extracellular vesicles in cancer diagnosis and treatment) which are most often diamagnetic.

In some aspects, described herein is an apparatus for separation of diamagnetic particles, the apparatus including: a first magnetic coil including a hollow center; and a separation unit including an outer enclosure and a second magnetic coil, wherein the second magnetic coil includes a single-layer of windings of a magnetic wire and at least one nonmagnetic wire on a nonmagnetic core; wherein the first magnetic coil houses the separation unit in the hollow inner center; and wherein the apparatus is configured to receive a fluid including diamagnetic particles.

In other aspects, a method of using the apparatus is disclosed.

Additional advantages of the disclosed devices, systems, and methods will be set forth in part in the description which follows, and in part will be obvious from the description. The advantages of the disclosed devices, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The accompanying figures, which are incorporated in and constitute a part of this specification, illustrate several aspects of the disclosure, and together with the description, serve to explain the principles of the disclosure.

FIG. 1 shows an embodiment of the separation unit (i.e. magnetic field-flow fractionation).

FIG. 2, panels A-C, show an embodiment of the apparatus including a first embodiment (FIG. 2, panel A), a second embodiment (FIG. 2, panel B), and a third embodiment (FIG. 2, panel C).

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

The devices, methods, and systems described herein may be understood more readily by reference to the following detailed description of specific aspects of the disclosed subject matter and the Examples included therein.

Before the present devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. As used in the specification and in the claims, the term “comprising” can include the aspects “consisting of” and “consisting essentially of.”

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein the term “plurality” means 2 or more (e.g., 3 or more; 4 or more; 5 or more; 10 or more; 15 or more; 20 or more; 25 or more; 30 or more; 40 or more; 50 or more; 75 or more; 100 or more; 150 or more; 200 or more; 250 or more; 300 or more; 400 or more; 500 or more; 750 or more; 1000 or more; 1500 or more; 2000 or more; 2500 or more; 3000 or more; 4000 or more; or 5000 or more).

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

### Apparatus and Methods of Use Thereof

Disclosed herein is an apparatus for segregating submicron diamagnetic particles, from nonmagnetic and paramagnetic materials. The apparatus can be manufactured at a low-cost of material and labor and can be used with either resistive magnets or with superconducting magnets. In an embodiment where the apparatus comprises resistive magnets, the apparatus can separate diamagnetic particles with radius in the order of a few hundreds of nm. In another embodiment where the apparatus comprises superconducting magnets, the apparatus can separate diamagnetic particles with a radius as low as a few tens of nm.

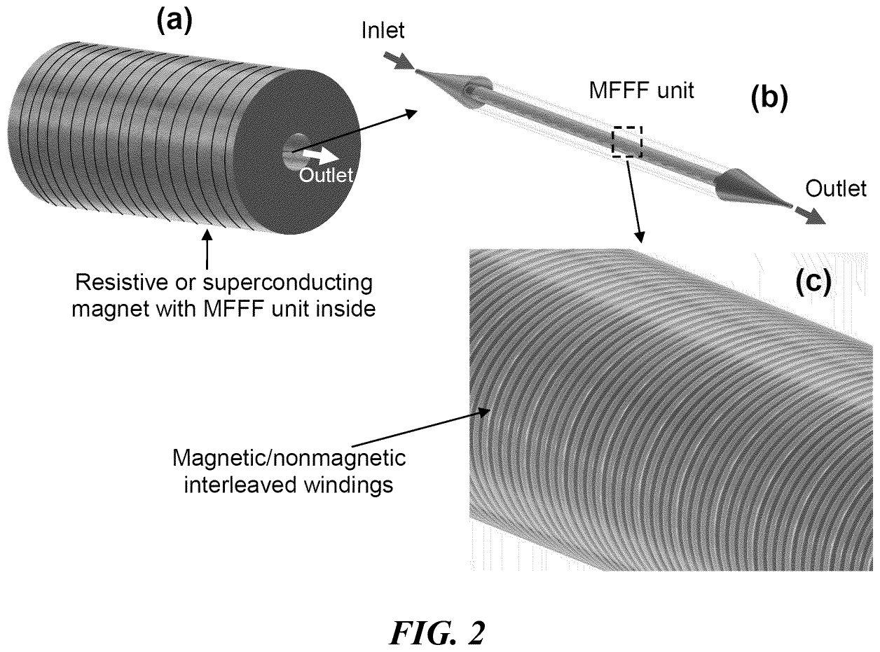

Referring now to FIG. 2, in some embodiments, the apparatus for separation of diamagnetic particles includes a first magnetic coil including a hollow center (see FIG. 2, panel A), and a separation unit (see FIG. 2, panel B, “MFFF unit”) including an outer enclosure and a second magnetic coil, wherein the second magnetic coil includes a single-layer of windings of a magnetic wire and at least one nonmagnetic wire on a nonmagnetic core (see FIG. 2, panel C); wherein the first magnetic coil houses the separation unit in the hollow inner center (see FIG. 2, panel A); and wherein the apparatus is configured to receive a fluid including diamagnetic particles.

In some embodiments, the first magnetic coil is configured to produce a magnetic field in the hollow center. For example, the first magnetic coil may form a solenoid.

In some embodiments, the first magnetic coil is configured to produce a magnetic field having a strength of 1 Tesla (T) or more (e.g., 1.25 T or more, 1.5 T or more, 1.75 T or more, 2 T or more, 2.25 T or more, 2.5 T or more, 2.75 T or more, 3 T or more, 3.25 T or more, 3.5 T or more, 3.75 T or more, 4 T or more, 4.25 T or more, 4.5 T or more, 4.75 T or more, 5 T or more, 5.25 T or more, 5.5 T or more, 5.75 T or more, 6 T or more, 6.25 T or more, 6.5 T or more, 6.75 T or more, 7 T or more, 7.25 T or more, 7.5 T or more, 7.75 T or more, 8 T or more, 8.25 T or more, 8.5 T or more, 8.75 T or more, 9 T or more, 9.25 T or more, 9.5 T or more, 9.75 T or more, 10 T or more, 10.25 T or more, 10.5 T or more, 10.75 T or more, 11 T or more, 11.25 T or more, 11.5 T or more, 11.75 T or more, 12 T or more, 12.25 T or more, 12.5 T or more, 12.75 T or more, 13 T or more, 13.25 T or more, 13.5 T or more, 13.75 T or more, 14 T or more, 14.25 T or more, 14.5 T or more, 14.75 T or more, 15 T or more, 15.25 T or more, 15.5 T or more, 15.75 T or more, 16 T or more, 16.25 T or more, 16.5 T or more, 16.75 T or more, 17 T or more, 17.25 T or more, 17.5 T or more, 17.75 T or more, 18 T or more, 18.25 T or more, 18.5 T or more, 18.75 T or more, 19 T or more, 19.25 T or more, 19.5 T or more, 19.75 T or more, 20 T or more, 20.25 T or more, 20.5 T or more, or 20.75 T or more).

In some embodiments, the first magnetic coil is configured to produce a magnetic field having a strength of 1 Tesla or more (e.g., 2 T or more; 3 T or more; 5 T or more; 10 T or more; or 20 T or more). For example, the magnetic field strength may be 1.25 T, 1.5 T, 1.75 T, 2.25 T, 2.5 T, 2.75 T, 3.25 T, 3.5 T, 3.75 T, 4.25 T, 4.5 T, 4.75 T, 5.25 T, 5.5 T, 5.75 T, 6.25 T, 6.5 T, 6.75 T, 7.25 T, 7.5 T, 7.75 T, 8.25 T, 8.5 T, 8.75 T, 9.25 T, 9.5 T, 9.75 T, 9.25 T, 10.5 T, 10.75 T, 11.25 T, 11.5 T, 11.75 T, 12.25 T, 12.5 T, 12.75 T, 13.25 T, 13.5 T, 13.75 T, 14.25 T, 14.5 T, 14.75 T, 15.25 T, 15.5 T, 15.75 T, 16.25 T, 16.5 T, 16.75 T, 17.25 T, 17.5 T, 17.75 T, 18.25 T, 18.5 T, 18.75 T, 19.25 T, 19.5 T, 19.75 T, 20.25 T, 20.5 T, or 20.75 T.

In some aspects, the direction of the magnetic field is parallel to a longitudinal axis of the apparatus.

In some embodiments, the first magnetic coil includes a resistive or superconducting material. In some examples, a resistive material comprises aluminum, copper, or combinations thereof. In some examples, a superconducting material comprises niobium-tin, niobium-titanium, copper, and alloys thereof.

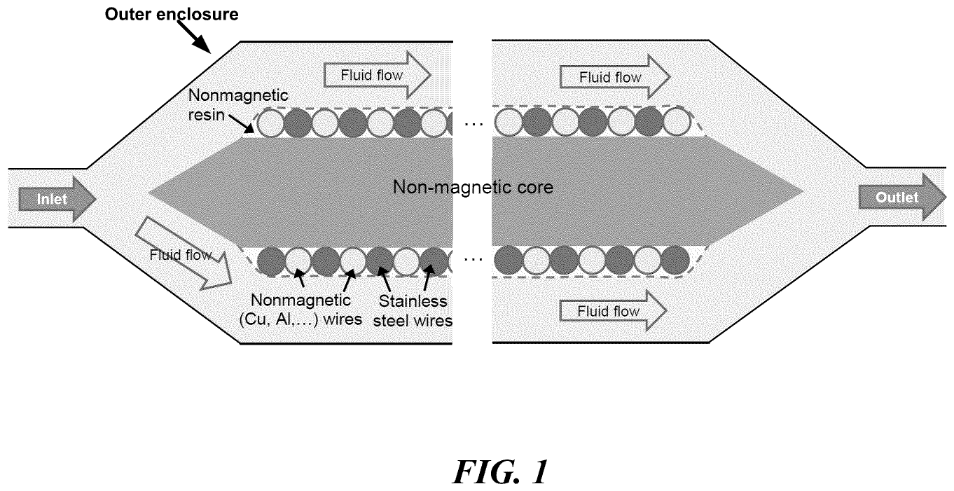

Referring now to FIG. 1, in some embodiments, the single-layer of windings includes interleaved windings of the magnetic wire and the at least one nonmagnetic wire. In some embodiments, the magnetic wire of the second magnetic coil includes stainless steel. In some embodiments, the at least one nonmagnetic wire includes aluminum, copper, or combinations thereof.

In some embodiments, the magnetic wire and the at least one nonmagnetic wire of the single-layer of windings have a same diameter. In some embodiments, the magnetic wire and the at least one nonmagnetic wire have a diameter of 0.1 μm to 100 μm. In some embodiments, the magnetic wire and the at least one nonmagnetic wire of the single-layer of windings have a same diameter, and wherein the magnetic wire and the at least one nonmagnetic wire have a diameter of 0.1 μm to 100 μm.

For example, the magnetic wire and the at least one nonmagnetic wire have a diameter of 0.1 micrometers (microns, μm) or more (e.g., 0.2 μm or more, 0.3 μm or more, 0.4 μm or more, 0.5 μm or more,1 μm or more, 1.5 μm or more, 2 μm or more, 2.5 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 15 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the magnetic wire and the at least one nonmagnetic wire have a diameter of 100 μm or less (e.g., 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, 30 μm or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.5 μm or less,1 μm or less, 0.5 μm or less, 0.4 μm or less, 0.3 μm or less, or 0.2 μm or less). The diameter can range from any of the minimum values described above to any of the maximum values described above. For example, the magnetic wire and the at least one nonmagnetic wire can have a diameter of from 0.1 μm to 100 μm (e.g., from 0.1 to 50 μm; from 50 to 100 μm; from 0.1 to 20 μm; from 20 to 40 μm; from 40 to 60 μm; from 60 to 80 μm; from 80 to 100 μm; from 0.1 μm to 90 μm; from 0.1 μm to 80 μm; from 0.1 μm to 70 μm; from 0.1 μm to 60 μm; from 0.1 μm to 40 μm; from 0.1 μm to 30 μm; from 0.1 μm to 10 μm; from 0.1 μm to 1 μm; from 1 μm to 100 μm; from 1 μm to 90 μm; from 1 μm to 80 μm; from 1 μm to 70 μm; from 1 μm to 60 μm; from 1 μm to 50 μm; from 1 μm to 40 μm; from 1 μm to 30 μm; from 1 μm to 20 μm; from 1 μm to 10 μm; from 10 μm to 100 μm; from 10 μm to 90 μm; from 10 μm to 80 μm; from 10 μm to 70 μm; from 10 μm to 60 μm; from 10 μm to 50 μm; from 10 μm to 40 μm; from 10 μm to 30 μm; from 10 μm to 20 μm; from 20 μm to 100 μm; from 20 μm to 90 μm; from 20 μm to 80 μm; from 20 μm to 70 μm; from 20 μm to 60 μm; from 20 μm to 50 μm; from 20 μm to 40 μm; from 20 μm to 30 μm; from 30 μm to 100 μm; from 30 μm to 90 μm; from 30 μm to 80 μm; from 30 μm to 70 μm; from 30 μm to 60 μm; from 30 μm to 50 μm; from 30 μm to 40 μm; from 40 μm to 100 μm; from 40 μm to 90 μm; from 40 μm to 80 μm; from 40 μm to 70 μm; from 40 μm to 60 μm; from 40 μm to 50 μm; from 50 μm to 100 μm; from 50 μm to 90 μm; from 50 μm to 80 μm; from 50 μm to 70 μm; from 50 μm to 60 μm; from 60 μm to 100 μm; from 60 μm to 90 μm; from 60 μm to 80 μm; from 60 μm to 70 μm; from 70 μm to 100 μm; from 70 μm to 90 μm; from 70 μm to 80 μm; from 80 μm to 100 μm; from 80 μm to 90 μm; or from 90 μm to 100 μm).

For example, the magnetic wire and the at least one nonmagnetic wire have a diameter of 0.1 μm to 90 μm; 0.1 μm to 80 μm; 0.1 μm to 70 μm; 0.1 μm to 60 μm; 0.1 μm to 50 μm; 0.1 μm to 40 μm; 0.1 μm to 30 μm; 0.1 μm to 20 μm; 0.1 μm to 10 μm; 0.1 μm to 1 μm; 1 μm to 100 μm; 1 μm to 90 μm; 1 μm to 80 μm; 1 μm to 70 μm; 1 μm to 60 μm; 1 μm to 50 μm; 1 μm to 40 μm; 1 μm to 30 μm; 1 μm to 20 μm; 1 μm to 10 μm; 10 μm to 100 μm; 10 μm to 90 μm; 10 μm to 80 μm; 10 μm to 70 μm; 10 μm to 60 μm; 10 μm to 50 μm; 10 μm to 40 μm; 10 μm to 30 μm; 10 μm to 20 μm; 20 μm to 100 μm; 20 μm to 90 μm; 20 μm to 80 μm; 20 μm to 70 μm; 20 μm to 60 μm; 20 μm to 50 μm; 20 μm to 40 μm; 20 μm to 30 μm; 30 μm to 100 μm; 30 μm to 90 μm; 30 μm to 80 μm; 30 μm to 70 μm; 30 μm to 60 μm; 30 μm to 50 μm; 30 μm to 40 μm; 40 μm to 100 μm; 40 μm to 90 μm; 40 μm to 80 μm; 40 μm to 70 μm; 40 μm to 60 μm; 40 μm to 50 μm; 50 μm to 100 μm; 50 μm to 90 μm; 50 μm to 80 μm; 50 μm to 70 μm; 50 μm to 60 μm; 60 μm to 100 μm; 60 μm to 90 μm; 60 μm to 80 μm; 60 μm to 70 μm; 70 μm to 100 μm; 70 μm to 90 μm; 70 μm to 80 μm; 80 μm to 100 μm; 80 μm to 90 μm; or 90 μm to 100 μm. Exemplary diameters include 0.2 μm, 0.5 μm, 1 μm, 5 μm, 10 μm, 15 μm, 25 μm, 35 μm, 45 μm, 55 μm, 65 μm, 75 μm, 85 μm, and 95 μm.

In some embodiments, the single-layer of windings includes two or more nonmagnetic wires. In some embodiments, the two or more nonmagnetic wires are configured to increase a distance between windings of the magnetic wire. In some embodiments, the single-layer of windings includes two or more nonmagnetic wires, wherein the two or more nonmagnetic wires are configured to increase a distance between windings of the magnetic wire. For example, the one magnetic wire is interleaved with two nonmagnetic wires, thereby increasing the distance between magnetic wire turns. In another example, the one magnetic wire is interleaved with three nonmagnetic wires. In yet another example, the one magnetic wire is interleaved with four nonmagnetic wires.

In some embodiments, the separation unit further includes a coating disposed on the nonmagnetic inner core and enveloping the single-layer of windings. For example, the coating includes a nonmagnetic resin (see FIG. 1, “nonmagnetic resin”).

In some embodiments, the coating is disposed on the nonmagnetic inner core and has a total height of at least 99% or more of the diameter of the single-layer windings (e.g., 100% or more, 101% or more, 102% or more, 103% or more, 104% or more, 105% or more, 110% or more, 115% or more, 120% or more, 125% or more, 130% or more, 135% or more, 140% or more, or 145% or more). In some embodiments, the coating is disposed on the nonmagnetic inner core and has a total height of up to 150% of the diameter of the single-layer windings (e.g., 145% or less, 140% or less, 135% or less, 130% or less, 125% or less, 120% or less, 115% or less, 110% or less, 105% or less, 104% or less, 103% or less, 102% or less, 101% or less, or 100% or less). The total height of the coating relative to the diameter of the single-layer windings can range from any of the minimum values described above to any of the maximum values described above. For example, the coating disposed on the nonmagnetic inner core can have a total height of from at least 99% up to 150% of the diameter of the single-layer winding (e.g., from 99% to 125%, from 125% to 150%, from 99% to 110%, from 110% to 120%, from 120% to 130%, from 130% to 140%, from 140% to 150%, from 99% to 140%, from 99% to 130%, from 99% to 120%, from 99% to 110%, from 100% to 150%, from 100% to 140%, from 100% to 130%, from 100% to 120%, from 100% to 110%, from 110% to 150%, from 120% to 150%, from 130% to 150%, from 100% to 140%, or from 110% to 130%).

In some embodiments, the coating is disposed on the nonmagnetic inner core and has a total height of at least 99% of the diameter of the single-layer windings and up to 150% of the diameter of the single-layer windings. In some aspects, the coating occupies all of or a majority of the voids between windings of the single-layer windings and voids between windings of the single-layer windings and the nonmagnetic inner core. In one example, the coating has a total height of 99% of the diameter of the single-layer windings, thereby a top portion of the single-layer windings is exposed. In another example, the coating has a total height of 101%, 110%, 120%, 130%, 140% or 150% of the diameter of the single-layer windings, thereby forming a coating atop the single-layer windings. It should be understood that the efficiency of the apparatus is inversely proportional to the height of the coating relative to the single-layer windings. It is contemplated that an increase in coating height may be preferable for corrosive or highly corrosive fluid processing.

In some examples, the nonmagnetic core has a diameter of 0.5 centimeters (cm) or more (e.g., 0.6 cm or more, 0.7 cm or more, 0.8 cm or more, 0.9 cm or more, 1.0 cm or more, 1.25 cm or more, 1.5 cm or more, 1.75 cm or more, 2.0 cm or more, 2.25 cm or more, 2.5 cm or more, 3.0 cm or more, 3.5 cm or more, 4.0 cm or more, 4.5 cm or more, 5.0 cm or more, 5.5 cm or more, 6.0 cm or more, 6.5 cm or more, 7.0 cm or more, 7.5 cm or more, 8.0 cm or more, 8.5 cm or more, 9.0 cm or more, or 9.5 cm or more). In some examples, the nonmagnetic core has a diameter of 10 cm or less (e.g., 9.5 cm or less, 9.0 cm or less, 8.5 cm or less, 8.0 cm or less, 7.5 cm or less, 7.0 cm or less, 6.5 cm or less, 6.0 cm or less, 5.5 cm or less, 5.0 cm or less, 4.5 cm or less, 4.0 cm or less, 3.5 cm or less, 3.0 cm or less, 2.5 cm or less, 2.25 cm or less, 2.0 cm or less, 1.75 cm or less, 1.5 cm or less, 1.25 cm or less, 1.0 cm or less, 0.9 cm or less, 0.8 cm or less, 0.7 cm or less, or 0.6 cm or less). The diameter of the nonmagnetic core can range from any of the minimum values described above to any of the maximum values described above. For example, the nonmagnetic core can have a diameter of from 0.5 cm to 10 cm (e.g., from 0.5 to 5 cm; from 5 to 10 cm; from 0.5 to 2 cm; from 2 to 4 cm; from 4 to 6 cm; from 6 to 8 cm; from 8 to 10 cm; from 2 cm to 10 cm; from 3 cm to 10 cm; from 4 cm to 10 cm; from 5 cm to 10 cm; from 6 cm to 10 cm; from 7 cm to 10 cm; from 8 cm to 10 cm; from 9 cm to 10 cm; from 0.5 cm to 9 cm; from 1 cm to 9 cm; from 2 cm to 9 cm; from 3 cm to 9 cm; from 4 cm to 9 cm; from 5 cm to 9 cm; from 6 cm to 9 cm; from 7 cm to 9 cm; from 8 cm to 9 cm; from 0.5 cm to 8 cm; from 1 cm to 8 cm; from 2 cm to 8 cm; from 3 cm to 8 cm; from 4 cm to 8 cm; from 5 cm to 8 cm; from 6 cm to 8 cm; from 7 cm to 8 cm; from 0.5 cm to 7 cm; from 1 cm to 7 cm; from 2 cm to 7 cm; from 3 cm to 7 cm; from 4 cm to 7 cm; from 5 cm to 7 cm; from 6 cm to 7 cm; from 0.5 cm to 6 cm; from 1 cm to 6 cm; from 2 cm to 6 cm; from 3 cm to 6 cm; from 4 cm to 6 cm; from 5 cm to 6 cm; from 0.5 cm to 5 cm; from 1 cm to 5 cm; from 2 cm to 5 cm; from 3 cm to 5 cm; from 4 cm to 5 cm; from 0.5 cm to 4 cm; from 1 cm to 4 cm; from 2 cm to 4 cm; from 3 cm to 4 cm; from 0.5 cm to 3 cm; from 1 cm to 3 cm; from 2 cm to 3 cm; from 0.5 cm to 2 cm; from 1 cm to 2 cm; or from 0.5 cm to 1 cm).

In some embodiments, the nonmagnetic core has a diameter of 0.5 cm to 10 cm. In some examples, the nonmagnetic core has a diameter of 1 cm to 10 cm; 2 cm to 10 cm; 3 cm to 10 cm; 4 cm to 10 cm; 5 cm to 10 cm; 6 cm to 10 cm; 7 cm to 10 cm; 8 cm to 10 cm; 9 cm to 10 cm; 0.5 cm to 9 cm; 1 cm to 9 cm; 2 cm to 9 cm; 3 cm to 9 cm; 4 cm to 9 cm; 5 cm to 9 cm; 6 cm to 9 cm; 7 cm to 9 cm; 8 cm to 9 cm; 0.5 cm to 8 cm; 1 cm to 8 cm; 2 cm to 8 cm; 3 cm to 8 cm; 4 cm to 8 cm; 5 cm to 8 cm; 6 cm to 8 cm; 7 cm to 8 cm; 0.5 cm to 7 cm; 1 cm to 7 cm; 2 cm to 7 cm; 3 cm to 7 cm; 4 cm to 7 cm; 5 cm to 7 cm; 6 cm to 7 cm; 0.5 cm to 6 cm; 1 cm to 6 cm; 2 cm to 6 cm; 3 cm to 6 cm; 4 cm to 6 cm; 5 cm to 6 cm; 0.5 cm to 5 cm; 1 cm to 5 cm; 2 cm to 5 cm; 3 cm to 5 cm; 4 cm to 5 cm; 0.5 cm to 4 cm; 1 cm to 4 cm; 2 cm to 4 cm; 3 cm to 4 cm; 0.5 cm to 3 cm; 1 cm to 3 cm; 2 cm to 3 cm; 0.5 cm to 2 cm; 1 cm to 2 cm; or 0.5 cm to 1 cm. Exemplary diameters include 0.6 cm, 0.7 cm, 0.8 cm, 0.9 cm, 1.0 cm, 1.2 cm, 1.5 cm, 2.0 cm, 2.5 cm, 3.0 cm, 3.5 cm, 4.0 cm, 4.5 cm, 5.0 cm, 5.5 cm, 6.0 cm, 6.5 cm, 7.0 cm, 7.5 cm, 8.0 cm, 8.5 cm, 9.0 cm, or 9.5 cm.

In some embodiments, the nonmagnetic core includes a plastic, polymers, aluminum, or other nonmagnetic metals.

In some embodiments, a diameter of the second magnetic coil includes the sum of the diameter of the nonmagnetic inner core and two times the height of the coating.

In some embodiments, the second magnetic coil is configured to produce a magnetic gradient on the order of 10⁴ T²/m or more (e.g., 1×10⁴ T/m² or more, 2×10⁴ T/m² or more, 3×10⁴ T/m² or more, 4×10⁴ T/m² or more, 5×10⁴ T/m² or more, 6×10⁴ T/m² or more, 7×10⁴ T/m² or more, 8×10⁴ T/m² or more, 9×10⁴ T/m² or more, 1×10⁵ T/m² or more, 2×10⁵ T/m² or more, 3×10⁵ T/m² or more, 4×10⁵ T/m² or more, 5×10⁵ T/m² or more, 6×10⁵ T/m² or more, 7×10⁵ T/m² or more, 8×10⁵ T/m² or more, 9×10⁵ T/m² or more, 1×10⁶ T/m² or more, 2 ×10⁶ T/m² or more, 3×10⁶ T/m² or more, 4×10⁶ T/m² or more, 5×10⁶ T/m² or more, 6×10⁶ T/m² or more, 7×10⁶ T/m² or more, 8×10⁶ T/m² or more, or 9×10⁶ T/m² or more). In some examples, the second magnetic coil is configured to produce a magnetic gradient on the order of up to 10⁷ T²/m (e.g., 9×10⁶ T/m² or less, 8×10⁶ T/m² or less, 7×10⁶ T/m² or less, 6×10⁶ T/m² or less, 5 ×10⁶ T/m² or less, 4×10⁶ T/m² or less, 3×10⁶ T/m² or less, 2×10⁶ T/m² or less, 1×10⁶ T/m² or less, 9×10⁵ T/m² or less, 8×10⁵ T/m² or less, 7×10⁵ T/m² or less, 6×10⁵ T/m² or less, 5×10⁵ T/m² or less, 4×10⁵ T/m² or less, 3×10⁵ T/m² or less, 2×10⁵ T/m² or less, 1×10⁵ T/m² or less, 9×10⁴ T/m² or less, 8×10⁴ T/m² or less, 7×10⁴ T/m² or less, 6×10⁴ T/m² or less, 5×10⁴ T/m² or less, 4×10⁴ T/m² or less, 3×10⁴ T/m² or less, or 2×10⁴ T/m² or less). The magnetic gradient produced by the second magnetic coil can range from any of the minimum values described above to any of the maximum values described above. For example, the second magnetic coil can be configured to produce a magnetic gradient on the order of from 10⁴ T²/m up to 10⁷ T²/m (e.g., from 1×10⁴ to 5×10⁵ T/m², from 5×10⁵ to 10⁷ T/m², from 1×10⁴ to 1×10⁵ T/m², from 1×10⁵ to 1×10⁶ T/m², from 1×10⁶ to 1×10⁷ T/m², or from 5×10⁴ to 5×10⁶ T/m²).

In some embodiments, the second magnetic coil is configured to produce a magnetic gradient on the order of 10⁴ T²/m up to 10⁷ T²/m. In some examples, the magnetic gradient is on the order of 10⁵ T²/m, 10⁶ T²/m, or 10⁷ T²/m.

In some embodiments, the separation unit further includes a fluid flow region wherein the fluid flow region includes the space between the outer enclosure and the second magnetic coil. In some embodiments, the fluid flow region has a height that is at least equal to the diameter of the single-layer windings and up to 100 times the diameter of the single-layer windings. In some examples, the height of the fluid flow region is 1.0 times, 2 times, 3 times, 5 times, 10 times, 50 times, 60 times, 70 times, 80 times, 90 times, or 100 times the diameter of the single-layer windings. It should be understood that the height of the fluid flow region is inversely proportional to the efficiency of the apparatus. In a preferred embodiment, the fluid flow region height is between 1.0 times and 2.0 times the diameter of the single-layer windings. Exemplary values of the height of the fluid flow region include 1.1 times, 1.2 times, 1.3 times, 1.4 times, 1.5 times, 1.6 times, 1.7 times, 1.8 times, and 1.9 times the diameter of the single-layer windings.

In some embodiments, the outer enclosure has an inner diameter that is greater than or equal to the sum of the diameter of the second magnetic coil and two times the height of the fluid flow region.

In some embodiments, the separation unit includes a fluid inlet and a fluid outlet along the longitudinal axis of the apparatus (see FIG. 1 and FIG. 2, panel B) and the fluid flow region therebetween along the longitudinal axis of the apparatus and defined by the outer enclosure and the second magnetic coil along a radial axis of the apparatus (see FIG. 1). In some embodiments, the fluid inlet is in fluidic communication with the fluid flow region, and the fluid flow region is in fluidic communication with the fluid outlet.

In some embodiments, the fluid includes an aqueous or organic fluid. The fluid may comprise a composition of diamagnetic particles; and paramagnetic particles, nonmagnetic particles, or combinations thereof. In some examples, the apparatus is configured to separate the diamagnetic particles from paramagnetic particles having the same or similar diameter.

In some embodiments, the diamagnetic particles have a diameter of 5 μm or less (e.g., 4.5 μm or less, 4 μm or less, 3.5 μm or less, 3 μm or less, 2.5 μm or less, 2 μm or less, 1.5 μm or less, 1 μm or less, 0.5 μm or less, 0.1 μm or less, 0.05 μm or less, or 0.01 μm or less). In some embodiments, the diamagnetic particles have a diameter of 2 μm or less.

In some embodiments, the diamagnetic particles have a diameter of 5 μm or less. For example, the diamagnetic particles have diameter of 4 μm or less, 3 μm or less, 2 μm or less, 1 μm or less, 0.1 μm or less, or 0.01 μm or less. Exemplary diameters of diamagnetic particles that can be separated from the fluid using the apparatus include diameters of 4.5 μm, 3.5 μm, 2.5 μm, 1.5 μm, 0.5 μm, 0.05 μm, 0.04 μm, 0.03 μm, or 0.02 μm.

In some embodiments, the diamagnetic particles that can be separated from the fluid using the apparatus have an absolute value of magnetic susceptibility on the order of 10⁻³ or less. In some examples, the magnetic susceptibility is on the order of 10⁻⁴ or less; 10⁻⁵ or less; or 10⁻⁶ or less. In some examples, the magnetic susceptibility is on the order of 10⁻⁴ or less.

In some embodiments, the diamagnetic particles include biological cells or active organic molecules. In other embodiments, the diamagnetic particles include yttrium, lanthanum, or combinations thereof. It should be understood that these disclosed diamagnetic particles are for example only. It is contemplated that any diamagnetic particle that has the characteristics as described can be separated using the apparatus.

Also disclosed herein are methods of use of any of the apparatuses disclosed herein.

In some embodiments, a method using the apparatus for separation of diamagnetic particles is disclosed. The method including providing a fluid comprising diamagnetic particles to the apparatus, wherein the first magnetic coil exhibits a magnetic field, and collecting the fluid from the apparatus, wherein the diamagnetic particles are removed or reduced in number in the fluid. This will, for example, separate the diamagnetic particles from the fluid.

In some embodiments, the method further includes removing the diamagnetic particles from the apparatus. Removing the diamagnetic particles from the apparatus includes removing the magnetic field from the first magnetic coil, providing a second fluid, wherein the diamagnetic particles are sequestered in the second fluid, and collecting the second fluid including the diamagnetic particles.

In some embodiments, providing the fluid includes providing the fluid with a flow rate of 0 cm/s or more (e.g., 0.1 cm/s or more, 0.2 cm/s or more, 0.3 cm/s or more, 0.4 cm/s or more, 0.5 cm/s or more, 0.6 cm/s or more, 0.7 cm/s or more, 0.8 cm/s or more, or 0.9 cm/s or more). In some embodiments, providing the fluid includes providing the fluid with a flow rate of 10 cm/s or less (e.g., 0.9 cm/s or less, 0.8 cm/s or less, 0.7 cm/s or less, 0.6 cm/s or less, 0.5 cm/s or less, 0.4 cm/s or less, 0.3 cm/s or less, 0.2 cm/s or less, or 0.1 cm/s or less). The flow rate of the fluid can range from any of the minimum values described above to any of the maximum values described above. For example, providing the fluid can include providing the fluid with a flow rate of from 0 to 1 cm/s (e.g., from 0 to 0.5 cm/s, from 0.5 to 1 cm/s, from 0 to 0.2 cm/s, from 0.2 to 0.4 cm/s, from 0.4 to 0.6 cm/s, from 0.6 to 0.8 cm/s, from 0.8 to 1 cm/s, from 0 to 0.8 cm/s, from 0 to 0.6 cm/s, from 0 to 0.4 cm/s, from 0.1 to 1 cm/s, from 0.2 to 1 cm/s, from 0.4 to 1 cm/s, from 0.6 to 1 cm/s, from 0.1 to 9 cm/s, or from 0.2 to 8 cm/s). In some examples, providing the fluid can include providing the fluid with a flow rate of from greater than 0 to 1 cm/s (e.g., from greater than 0 to 0.5 cm/s, from 0.5 to 1 cm/s, from greater than 0 to 0.2 cm/s, from 0.2 to 0.4 cm/s, from 0.4 to 0.6 cm/s, from 0.6 to 0.8 cm/s, from 0.8 to 1 cm/s, from greater than 0 to 0.8 cm/s, from greater than 0 to 0.6 cm/s, from greater than 0 to 0.4 cm/s, from 0.1 to 1 cm/s, from 0.2 to 1 cm/s, from 0.4 to 1 cm/s, from 0.6 to 1 cm/s, from 0.1 to 9 cm/s, or from 0.2 to 8 cm/s).

In some embodiments, providing the fluid includes providing the fluid with a flow rate of 0 to 1 cm/s. In some examples, the flow rate is 0.1 cm/s, 0.2 cm/s, 0.3 cm/s, 0.4 cm/s, 0.5 cm/s, 0.6 cm/s, 0.7 cm/s, 0.8 cm/s, or 0.9 cm/s. It is contemplated that the performance of the method may vary based on the fluid flow rate.

It is additionally contemplated that the apparatus may be adjusted to a desired application or target of the method. In some embodiments, the diameters of the magnetic wire and of the at least one nonmagnetic wire of the separation unit may be adjusted. For example, the magnetic wire and the at least one nonmagnetic wire of the single-layer of windings may have a diameter of 0.1 μm to 100 μm. In other embodiments, the radius of the nonmagnetic core of the second magnetic coil may be adjusted. For example, the nonmagnetic core may have a diameter of 0.5 cm to 10 cm.

In another embodiment, the thickness of the fluid layer around the windings of the separation unit may be adjusted. The fluid layer, i.e. the space of “fluid flow” as shown in FIG. 1, is defined by the outer enclosure, the thickness of the coating around the second magnetic coil, the diameter of the magnetic and at least one magnetic wire, and the diameter of the nonmagnetic core. The fluid layer therefor may be adjusted by varying the dimensions of any one or more of the defining constructs. For example, the magnetic wire and at least one magnetic wire diameter may vary between 0.1 μm and 100 μm, the coating may have a total height between 99% and 150% of the diameter of the single-layer windings, the nonmagnetic core diameter may vary between 0.5 cm and 10 cm, and the inner diameter of the outer enclosure may be greater than or equal to the sum of the diameter of the nonmagnetic core and two times the height of the coating.

In yet other aspects, the separation distance between the magnetic wires may be varied. The separation distance is proportional with the number of nonmagnetic windings between two magnetic windings. The separation distance may be varied by including one, two, three or more nonmagnetic wires in the second magnetic coil. In another embodiment, the magnetic field strength produced by the first magnetic coil may be adjusted; for example, the magnetic field strength may be 1 T or more.

The construction and arrangement of the systems and methods as shown in the various implementations are illustrative only. Although only a few implementations have been described in detail in this disclosure, many modifications are possible (e.g., variations in sizes, dimensions, structures, shapes, and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

It is to be understood that the methods and systems are not limited to specific synthetic methods, specific components, or to particular compositions. It is also to be understood that the terminology used herein is for the purpose of describing particular implementations only and is not intended to be limiting.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in °C or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

### Apparatus for the High-gradient Magnetic Separation of Nanoscale Diamagnetic Particles

Diamagnetic particles have magnetic susceptibilities of around 10⁻⁴, which is orders of magnitude smaller than the magnetic susceptibility of paramagnetic and ferromagnetic materials and only about tenfold larger than the magnetic susceptibility of water molecules. Due to the extremely small value of the magnetic susceptibility of diamagnetic particles, the magnetic separation of these particles is difficult. Currently, there exist two methods to separate diamagnetic particles from other paramagnetic or ferromagnetic particles.

The first method is based on using permanent or electromagnets arranged in a quadrupole structure to produce a nonlinear magnetic field that attracts the diamagnetic particles towards the center of the quadrupole and repels the paramagnetic and ferromagnetic particles towards the edges of the quadrupole [1]. This method has the advantage that it can create magnetic field gradients in a relatively large spatial volume, however, the value of the magnetic field gradients is relatively small (under 200 T²/m), for which reason, the method allows to separate only large diamagnetic particles (e.g., with radius larger than 10 μm).

The second method uses single permanent magnets placed near a microfluidic channel, through which the fluid containing the diamagnetic particles is flowing [2-5]. The flow is laminar and is often realized using flow cytometers to construct dual streams, in which the particles are attracted using magnetophoresis. The magnetic field gradient obtained in this structure is of the order of 10 T²/m, which is again too small to separate nanoscale diamagnetic particles.

The separation efficiency of both methods can be improved by using ferrofluids instead of aqueous solvents (like in references [2-5]), however, in this case, the methods are not be able to distinguish between diamagnetic and paramagnetic particles with susceptibilities much smaller than the susceptibility of the ferrofluid. For this reason, ferrofluids have been used only to separate diamagnetic particles by size (which, in fact, can be done much more efficiently using filtration or centrifugal separation) and not by particle type (i.e. by the value of the magnetic susceptibility). In addition, ferrofluids cannot be used on a large scale because of chemical contamination with the ferrofluid nanoparticles and because these particles are difficult to remove after the separation of diamagnetic particles.

To be able to attract diamagnetic particles with a radius of tens to hundreds of nanometers, one needs to use systems that are able to create magnetic field gradients over 10⁵ T²/m. Such high gradients can be achieved by using high-gradient magnetic separation (HGMS) systems, the most common such system consisting of a dense matrix of magnetic thin wires (usually made of stainless steel) placed in an external magnetic field [6]. Unfortunately, the magnetic, thin wires will attract equally the diamagnetic and the paramagnetic particles, making the existing HGMS systems practically impossible to separate these particles [7].

A goal of the present disclosure, is to propose a new, yet simple, apparatus for segregating submicron diamagnetic particles, from nonmagnetic and paramagnetic materials. The apparatus is low-cost, relatively simple to build and can be used with either resistive magnets (in which case it can separate diamagnetic particles with radius in the order of a few hundreds of nm) or with superconducting magnets (in which case it can separate diamagnetic particles with a radius as low as a few tens of nm).

The apparatus disclosed herein includes a combination of a specially designed HGMS system and a magnetic field-flow fractionation (MFFF) system. An MFFF system is a flow-based separation technique in which a magnetophoretic force is applied in the direction perpendicular to the flow of the fluid to move the particles that need to be separated towards the boundaries of the flow channel [8]. Since the fluid velocity decreases when the particles approach the boundary of the flow channel, MFFF can be used efficiently to separate the particles that interact with the magnetic force from the particles that do not interact with this force [9-10]. Notice that all of the existing MFFF systems proposed in the literature so far have been designed for paramagnetic and ferromagnetic particles, which have a much higher magnetic susceptibility than the diamagnetic particles [9]. These existing MFFF systems for paramagnetic and ferromagnetic separation are usually 3D printed and are able to produce magnetic field gradients up to 100 T²/m, which are too small for the separation of nanoscale diamagnetic particles.

The apparatuses disclosed herein include a special design of an MFF unit. In some examples, as shown in FIG. 1, the MFFF unit includes a multiple interleaved winding; the first one made of stainless steel while the other windings are made of a nonmagnetic material such as Al or Cu. The windings are tightly wrapped in a single layer around a nonmagnetic core and covered with a nonmagnetic resin. The windings together with the nonmagnetic core are inserted into a large coil capable of producing magnetic fields of at least 2 T (see FIG. 2, panel A). The coil can be either resistive or superconducting. The aqueous fluid containing the diamagnetic, paramagnetic, and nonmagnetic particles enters the MFFF unit on one side, splits around the nonmagnetic core and is collected at the output, as shown in FIG. 1 and FIG. 2, panel B. The role of the resin is twofold: first, it covers the spaces where paramagnetic particles could be attracted in-between the windings and, second, it chemically isolates windings from the liquid.

During the operation of the system, the external coil produces a relatively uniform magnetic field along the axis of the MFFF unit. This magnetic field magnetizes only the magnetic wires, which are distributed uniformly and at equal distances inside the MFFF unit. The external part of these wires produces a strong local magnetic field gradient, which attracts the diamagnetic particles and repels the paramagnetic particles, while the nonmagnetic particles are unaffected. Since the velocity of the liquid is smaller near the two windings than in the middle of the fluid region, the diamagnetic particles will travel at smaller speeds than the rest of the particles and can be separated in either in continuous mode (see for instance [2-5]) or in batches, such as in standard field-flow fractionation devices or column chromatographic cells. A number of diamagnetic particles can also attach to the stainless steel wires, and these particles can be released by removing the MFFF unit from the magnetic field.

The important design parameters of the system are: (1) the diameters of the magnetic and nonmagnetic wires, (2) the radius of the nonmagnetic core, (3) the thickness of the water layer around the windings, (4) the flow rate of the fluid, (5) the value of the external magnetic field produced by the coils, and (6) the separation distance between the magnetic wires, which is proportional with the number of nonmagnetic windings between two magnetic windings. These six parameters are strongly correlated with the minimum particle size and susceptibility of the diamagnetic particles that can be separated, the throughput of the device, the recovery, and grade of separation. They can be adjusted depending on the desired application. The values of the magnetic field gradient in the flow region are of the order of 10⁵ T²/m for wires with a diameter of 50 μm (which is relatively standard in commercial HGMS), but can be increased by more than two orders of magnitude by using submicrometer wires and superconducting magnets. For instance, if wires with a diameter of 0.5 μm are used, the magnetic field gradient reaches values of the order of 10⁷ T²/m and the system is capable of separating diamagnetic particles with a diameter as low as a few tens of nanometers.

The disclosed apparatus has a number of significant advantages over the existing HGMS chromatographic systems. First, the magnetic field gradients that can be reached by this system are three orders of magnitude larger than the magnetic field gradient obtained by the state-of-the-art diamagnetic separators that use quadrupole structures [1]; for this reason, the apparatus disclosed herein can separate much smaller diamagnetic particles than commercial separators. Second, because the apparatus disclosed herein requires only one magnetic coil, it is significantly easier to fabricate than systems based on quadrupole structures, which require four coils. It is noted that the apparatus disclosed herein can use a standard magnetic coil with an inner opening, which is readily available commercially in the form of both resistive and superconducting magnets. Third, the apparatus disclosed herein is able to separate diamagnetic from paramagnetic particles (note that traditional HGMS systems or systems that use ferrofluids are not able to segregate them if the particles have the same radius). Moreover, the apparatus disclosed herein is relatively easy to build; in particular the interleaved windings are easy to manufacture using commercial coil winding machines [11]. Finally, the apparatus disclosed herein is scalable where the throughput increases linearly with the radius of nonmagnetic core.

The commercial applications of the apparatus and methods disclosed herein are in the area of the separation of diamagnetic particles from raw materials. In particular, this is relevant to the extraction of elements such as yttrium and lanthanum (which are diamagnetic with a magnetic susceptibility of approximately −10⁻⁴) from raw materials. The apparatus can also be useful in medical applications, particularly for the separation of biological particles (e.g., cells, bacteria, and extracellular vesicles in cancer diagnosis and treatment) because most biological particles are diamagnetic in nature [3].

### REFERENCES

[1] U.S. Pat. No. 4,778,594
[2] A. Munaz, M. J. A. Shiddiky, and N.-T. Nguyen, “Magnetophoretic separation of diamagnetic particles through parallel ferrofluid streams,” Sens. Actuators B Chem., vol. 275, pp. 459-469, Dec. 2018, doi: 10.1016/j.snb.2018.07.176.
[3] C.-D. Xue, Z.-P. Sun, Y.-J. Li, J.-F. Chen, B. Liu, and K.-R. Qin, “Separation of micro and sub-micro diamagnetic particles in dual ferrofluid streams based on negative magnetophoresis,” ELECTROPHORESIS, vol. 41, no. 10-11, pp. 909-916, 2020, doi: 10.1002/elps.202000002.
[4] J. Zeng, Y. Deng, P. Vedantam, T.-R. Tzeng, and X. Xuan, “Magnetic separation of particles and cells in ferrofluid flow through a straight microchannel using two offset magnets,” J. Magn. Magn. Mater., vol. 346, pp. 118-123, Nov. 2013, doi: 10.1016/j.jmmm.2013.07.021.
[5] T. Zhu, F. Marrero, and L. Mao, “Continuous separation of non-magnetic particles inside ferrofluids,” Microfluid. Nanofluidics, vol. 9, no. 4, pp. 1003-1009, Oct. 2010, doi: 10.1007/s10404-010-0616-1.
[6] R. Birss and M. Parker, “Magnetic separation of diamagnetic particles,” IEEE Trans. Magn., vol. 15, no. 6, pp. 1523-1525, Nov. 1979, doi: 10.1109/TMAG.1979.1060440.
[7] R. Gerber and R. Birss, High Gradient Magnetic Separation. Chichester ; New York: Research Studies Pr Ltd, 1983.
[8] Y. Bi, X. Pan, L. Chen, and Q.-H. Wan, “Field-flow fractionation of magnetic particles in a cyclic magnetic field,” J. Chromatogr. A, vol. 1218, no. 25, pp. 3908-3914, Jun. 2011, doi: 10.1016/j.chroma.2011.04.065.
[9] S. Kim, Y. Okimoto, S. Murase, S. Noguchi, and H. Okada, “Characteristics of Magnetic Separation for Magnetic Particle and Ion by Magnetic Chromatography With Novel Magnetic Column,” IEEE Trans. Appl. Supercond., vol. 19, no. 3, pp. 2152-2156, Jun. 2009, doi: 10.1109/TASC.2009.2019143.
[10] M. Manouchehri, S. Seidi, and F. O. Abdullah, “Application of magnetic nanomaterials in magnetic-chromatography: A review,” Talanta, vol. 229, p. 122273, Jul. 2021, doi: 10.1016/j.talanta.2021.122273.
[11] “Winding machine,” Wikipedia. Mar. 18, 2024. Accessed: Sep. 07, 2024. [Online]. Available: https://en.wikipedia.org/w/index.php? title=Winding_machine&oldid=1214435533

### Example 2

### Apparatus for the High-gradient Magnetic Separation of Nanoscale Diamagnetic Particles

Described herein is an apparatus for separating submicron diamagnetic particles (with a magnetic susceptibility of around −0.0001), from nonmagnetic and paramagnetic materials. There is no patent or system described in the literature that can be used to separate diamagnetic particles with a radius below 1 μm from non-magnetic and paramagnetic particles of similar size. The apparatus presented here is capable of separating diamagnetic particle with a radius of 100 nm and less.

The apparatus described herein has a number of advantages over the existing high-gradient magnetic separator (HGMS) systems. First, the magnetic field gradients produced by the system described herein are three orders of magnitude larger than those in the state-of-the-art diamagnetic separators; hence, the system described herein can separate much smaller diamagnetic particles than commercial separators. Second, the system described herein requires only one magnetic coil, and is significantly easier to fabricate than systems based on quadrupole structures, which require four coils. Third, the apparatus described herein is able to separate diamagnetic from paramagnetic particles (while traditional HGMS or systems that use ferrofluids are not able to segregate them if the particles have the same radius).

The apparatus described herein can be used for the extraction of diamagnetic elements such as yttrium and lanthanum from raw materials. The apparatus can also be useful in medical applications, particularly for the separation of biological particles (e.g. cells, bacteria, and extracellular vesicles in cancer diagnosis and treatment) which are most often diamagnetic.

### EXEMPLARY ASPECTS

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Exemplary aspect 1. An apparatus for separation of diamagnetic particles, the apparatus comprising: a first magnetic coil comprising a hollow center; and a separation unit comprising an outer enclosure and a second magnetic coil, wherein the second magnetic coil comprises a single-layer of windings of a magnetic wire and at least one nonmagnetic wire on a nonmagnetic core; wherein the first magnetic coil houses the separation unit in the hollow center; and wherein the apparatus is configured to receive a fluid comprising diamagnetic particles.

Exemplary aspect 2. The apparatus of exemplary aspect 1, wherein the first magnetic coil is configured to produce a magnetic field in the hollow center, wherein a strength of the magnetic field is 1 T or more and a direction of the magnetic field is parallel to a longitudinal axis of the apparatus.

Exemplary aspect 3. The apparatus of exemplary aspect 1 or 2, wherein the second magnetic coil comprises interleaved windings of the magnetic wire and the at least one nonmagnetic wire.

Exemplary aspect 4. The apparatus of any one of exemplary aspects 1-3, wherein the magnetic wire of the second magnetic coil comprises stainless steel.

Exemplary aspect 5. The apparatus of any one of exemplary aspects 1-4, wherein the at least one nonmagnetic wire comprises aluminum, copper, or combinations thereof.

Exemplary aspect 6. The apparatus of any one of exemplary aspects 1-5, wherein the magnetic wire and the at least one nonmagnetic wire of the second magnetic coil have a same diameter.

Exemplary aspect 7. The apparatus of exemplary aspect 6, wherein the magnetic wire and the at least one nonmagnetic wire have a diameter of 0.1 μm to 100 μm.

Exemplary aspect 8. The apparatus of any one of exemplary aspects 1-7, wherein the separation unit comprises two or more nonmagnetic wires.

Exemplary aspect 9. The apparatus of exemplary aspect 8, wherein the two or more nonmagnetic wires are configured to increase a distance between windings of the magnetic wire.

Exemplary aspect 10. The apparatus of any one of exemplary aspects 1-9, wherein the second magnetic coil is configured to produce a magnetic gradient on the order of 104 T2/m up to 107 T2/m.

Exemplary aspect 11. The apparatus of any one of exemplary aspects 1-10, wherein the separation unit further comprises a coating disposed on the nonmagnetic core and enveloping the single-layer of windings.

Exemplary aspect 12. The apparatus of exemplary aspect 11, wherein the coating comprises a nonmagnetic resin.

Exemplary aspect 13. The apparatus of exemplary aspect 11 or 12, wherein the coating has a height of between 99% and 150% of a diameter of the single-layer of windings.

Exemplary aspect 14. The apparatus of any one of exemplary aspects 1-13, wherein the nonmagnetic core has a diameter of 0.5 cm to 10 cm.

Exemplary aspect 15. The apparatus of any one of exemplary aspects 1-14, wherein the nonmagnetic core comprises a plastic, polymers, aluminum, or other nonmagnetic metals.

Exemplary aspect 16. The apparatus of any one of exemplary aspects 13-15, wherein the separation unit further comprises a fluid flow region wherein the fluid flow region includes a space between the outer enclosure and the second magnetic coil, and wherein the fluid flow region has a height between the diameter of the single-layer windings and up to 100 times the diameter of the single-layer windings.

Exemplary aspect 17. The apparatus of exemplary aspect 16, wherein the outer enclosure has a diameter greater than or equal to a sum of the diameter of the nonmagnetic core, two times the height of the coating and two times the height of the fluid flow region.

Exemplary aspect 18. The apparatus of any one of exemplary aspects 11-17, wherein the separation unit comprises a fluid inlet and a fluid outlet along a longitudinal axis of the apparatus and a fluid flow region therebetween along the longitudinal axis of the apparatus and defined by the outer enclosure and the second magnetic coil along a radial axis of the apparatus.

Exemplary aspect 19. The apparatus of exemplary aspect 18, wherein the fluid inlet is in fluidic communication with the fluid flow region, and the fluid flow region is in fluidic communication with the fluid outlet.

Exemplary aspect 20. The apparatus of any one of exemplary aspects 1-19, wherein the first magnetic coil comprises a resistive or superconducting material.

Exemplary aspect 21. The apparatus of any one of exemplary aspects 1-20, wherein the fluid comprises an aqueous or organic fluid.

Exemplary aspect 22. The apparatus of any one of exemplary aspects 1-21, wherein the fluid further comprises paramagnetic particles, nonmagnetic particles, or combinations there.

Exemplary aspect 23. The apparatus of any one of exemplary aspects 1-22, wherein the diamagnetic particles have a diameter of 2 μm or less.

Exemplary aspect 24. The apparatus of any one of exemplary aspects 1-23, wherein the diamagnetic particles have a magnetic susceptibility on the order of 10-4.

Exemplary aspect 25. The apparatus of exemplary aspect 24, wherein the diamagnetic particles comprise biological cells or active organic molecules.

Exemplary aspect 26. The apparatus of any one of exemplary aspects 1-25, wherein the diamagnetic particles comprise yttrium, lanthanum, or other diamagnetic metals or ions or combinations thereof.

Exemplary aspect 27. A method for separation of diamagnetic particles, the method comprising: providing a fluid comprising diamagnetic particles to the apparatus of any one of exemplary aspects 1-26, wherein the first magnetic coil exhibits a magnetic field; and collecting the fluid from the apparatus of any one of claims 1-26, wherein the diamagnetic particles are removed or reduced in number in the fluid.

Exemplary aspect 28. The method of exemplary aspect 27, the method further comprising: removing the magnetic field from the first magnetic coil; providing a second fluid, wherein the diamagnetic particles are sequestered in the second fluid; and collecting the second fluid comprising the diamagnetic particles.

Exemplary aspect 29. The method of exemplary aspect 27 or 28, wherein providing the fluid comprises providing the fluid with a flow rate of 0 to 1 cm/s.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The devices and methods of the appended claims are not limited in scope by the specific devices and methods described herein, which are intended as illustrations of a few aspects of the claims and any devices and methods that are functionally equivalent are intended to fall within the scope of the claims. Various modifications of the devices and methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. An apparatus for separation of diamagnetic particles, the apparatus comprising:
a first magnetic coil comprising a hollow center; and
a separation unit comprising an outer enclosure and a second magnetic coil, wherein the second magnetic coil comprises a single-layer of windings of a magnetic wire and at least one nonmagnetic wire on a nonmagnetic core;
wherein the first magnetic coil houses the separation unit in the hollow center; and
wherein the apparatus is configured to receive a fluid comprising diamagnetic particles.

2. The apparatus of claim 1, wherein the first magnetic coil is configured to produce a magnetic field in the hollow center, wherein a strength of the magnetic field is 1 T or more and a direction of the magnetic field is parallel to a longitudinal axis of the apparatus.

3. The apparatus of claim 1, wherein the second magnetic coil comprises interleaved windings of the magnetic wire and the at least one nonmagnetic wire.

4. The apparatus of claim 1, wherein the magnetic wire and the at least one nonmagnetic wire of the second magnetic coil have a same diameter.

5. The apparatus of claim 4, wherein the magnetic wire and the at least one nonmagnetic wire have a diameter of 0.1 μm to 100 μm.

6. The apparatus of claim 1, wherein the separation unit comprises two or more nonmagnetic wires, wherein the two or more nonmagnetic wires are configured to increase a distance between windings of the magnetic wire.

7. The apparatus of claim 1, wherein the second magnetic coil is configured to produce a magnetic gradient on the order of 10⁴ T²/m up to 10⁷ T²/m.

8. The apparatus of claim 1, wherein the separation unit further comprises a coating disposed on the nonmagnetic core and enveloping the single-layer of windings.

9. The apparatus of claim 8, wherein the coating comprises a nonmagnetic resin.

10. The apparatus of claim 8, wherein the coating has a height of between 99% and 150% of a diameter of the single-layer of windings.

11. The apparatus of claim 1, wherein the nonmagnetic core has a diameter of 0.5 cm to 10 cm.

12. The apparatus of claim 10, wherein the separation unit further comprises a fluid flow region wherein the fluid flow region includes a space between the outer enclosure and the second magnetic coil, and wherein the fluid flow region has a height between the diameter of the single-layer windings and up to 100 times the diameter of the single-layer windings.

13. The apparatus of claim 12, wherein the outer enclosure has a diameter greater than or equal to a sum of the diameter of the nonmagnetic core, two times the height of the coating and two times the height of the fluid flow region.

14. The apparatus of claim 8, wherein the separation unit comprises a fluid inlet and a fluid outlet along a longitudinal axis of the apparatus and a fluid flow region therebetween along the longitudinal axis of the apparatus and defined by the outer enclosure and the second magnetic coil along a radial axis of the apparatus, wherein the fluid inlet is in fluidic communication with the fluid flow region, and the fluid flow region is in fluidic communication with the fluid outlet.

15. The apparatus of claim 1, wherein the fluid further comprises paramagnetic particles, nonmagnetic particles, or combinations thereof.

16. The apparatus of claim 1, wherein the diamagnetic particles have a diameter of 2 μm or less.

17. The apparatus of claim 1, wherein the diamagnetic particles have a magnetic susceptibility on the order of 10⁻⁴.

18. The apparatus of claim 17, wherein the diamagnetic particles comprise biological cells or active organic molecules.

19. The apparatus of claim 1, wherein the diamagnetic particles comprise yttrium, lanthanum, or other diamagnetic metals or ions or combinations thereof.

20. A method for separation of diamagnetic particles, the method comprising:
providing a fluid comprising diamagnetic particles to the apparatus of claim 1, wherein the first magnetic coil exhibits a magnetic field; and
collecting the fluid from the apparatus of claim 1, wherein the diamagnetic particles are removed or reduced in number in the fluid.
